(19) United States
(12) Patent Application Publication
(10) Pub. No.: US 2024/0399667 A1
(43) Pub. Date: Dec. 5, 2024

(54) DYNAMIC EXPOSURE STRATEGY

(71) Applicant: Ivoclar Vivadent AG, Schaan (LI)

(72) Inventors: Hendrik John, Buchs (CH); Christian Niedrig, Azmoos (CH); Lorenz Bonderer, Sargans (CH)

(21) Appl. No.: 18/675,396

(22) Filed: May 28, 2024

(30) Foreign Application Priority Data
Jun. 2, 2023 (EP) 23176960.5

(51) Int. Cl. B29C 64/393; B29C 64/129; B33Y 10/00; B33Y 30/00; B33Y 50/02

(52) U.S. Cl. CPC B29C 64/393; B29C 64/129; B33Y 10/00; B33Y 30/00; B33Y 50/02

(57) ABSTRACT

A printing method for producing a component, including the steps of calculating an energy input for a spatial region of the component on the basis of the optical parameters of a light-curable material; and curing the region of the component by light which generates the calculated energy input into the material.

### CROSS-REFERENCE TO RELATED APPLICATIONS

This application claims priority to European Patent Application No. 23176960.5 filed on Jun. 2, 2023, which is incorporated herein by reference in its entirety.

### TECHNICAL FIELD

The present invention relates to a printing method and a printing device for producing a component.

### BACKGROUND

In stereolithography 3D printing, a liquid material is polymerized by the effect of light. The liquid material is usually located in a trough with a transparent bottom, into which a print bed is immersed from above and moves towards the bottom of the trough up to the desired layer thickness. The liquid material in the intermediate gap is then exposed to light at the desired points through the transparent trough bottom by means of an exposure device, for example by means of spot illumination using a laser beam raster or full-surface illumination using a micromirror array (DMD—Digital Mirror Device).

With sufficient exposure energy above the polymerization threshold of the printing liquid, it is polymerized, i.e., cured, at the exposed points. The print bed then moves upwards with the adhering cured layer and creates the necessary intermediate gap between the already cured layer and the bottom of the trough for the next layer. This is followed by the next exposure. In this way, a three-dimensional component can be built up layer by layer.

The layer-specific geometry to be polymerized is fully exposed. At the edges of the exposed shape, light is scattered through the liquid material and also scattered through the polymerized material, which has been successively cured during the exposure time.

As a consequence, unwanted cured material flakes form on the component or between the layers of the component, which on the one hand impair the fit of the component and on the other hand cause individual layers of the component to detach (delaminate) at the bottom of the trough. Delamination also occurs if the exposure energy is not sufficient to fully cure the desired layer thickness of the liquid material set by the print job or if the previous layer has polymerized too much.

A change in the chemical composition of the material leads to negative changes in other properties, e.g., mechanical stability, and does not solve the fundamental problem. The intensity of the light used also has an influence. If the total irradiated energy remains the same, flake formation increases at higher intensities. Higher intensities reduce the necessary exposure times per layer and are therefore largely responsible for the overall duration of the printing process, which should be as short as possible.

US 20220088873, 20130123988 and 20220001601 are directed to additive manufacturing methods and/or systems and are hereby incorporated by reference in their entirety.

### SUMMARY

It is the technical task of the invention to improve a printing process in such a way that the formation of material flakes and a delamination of layers is prevented.

This technical task is solved by subject matter according to the independent claims. Technically advantageous embodiments are the subject matter of the dependent claims, the description and the drawings.

According to a first aspect, the technical task is solved by a printing method for producing a component, comprising the steps of calculating an energy input for a spatial region of the component on the basis of the optical parameters of a light-curable material; and curing the spatial region of the component by means of light, which generates the calculated energy input in the material. The calculation can be performed as a function of the changing degree of polymerization over the exposure time. The light can change dynamically over the exposure time. The region of the component can be formed by a sub-region, such as a voxel. This allows each sub-region of the component to be selectively exposed. The optical parameters can comprise a scattering coefficient, an absorption coefficient and/or a transmission coefficient. The energy input into the region can be caused by direct illumination from a light source and/or indirect illumination by scattering from neighboring regions. The method provides the technical advantage that the component can be produced with greater precision.

In a technically advantageous embodiment of the printing method, the calculation is based on a geometry of the component. This provides the technical advantage, for example, that even narrow areas or acute angles can be printed without flaking.

In a further technically advantageous embodiment of the printing method, a time course of the energy input is calculated. This provides the technical advantage, for example, that the production of the component is improved even further.

In a further technically advantageous embodiment of the printing method, the time course is calculated on the basis of a temporal or spatial polymerization of the region. This provides the technical advantage, for example, that the progress of a polymerization is taken into account during the exposure and the polymerization in the layer is as uniform as possible in the cross-sectional area of the object.

In a further technically advantageous embodiment of the printing method, an intensity of an exposure is changed based on the time course of the energy input. The intensity can thus be changed as a function of time. For example, the intensity of the exposure changes over time. This provides the technical advantage, for example, of reducing over-exposure and thus flake formation and enabling the component to be produced with a high degree of accuracy.

In a further technically advantageous embodiment of the printing method, an area of exposure is changed based on the time course of the energy input. The exposed area can thus be changed as a function of time. This provides the technical advantage, for example, that the energy input can be easily controlled.

In a further technically advantageous embodiment of the printing method, a repetition frequency of a periodic exposure is changed over time based on the time course. A periodic exposure uses individual light pulses or flashes of light to cure the light-curing material. This provides the technical advantage, for example, that the energy input can be easily controlled.

In a further technically advantageous embodiment of the printing method, the optical parameters of the light-curable material are measured. The optical parameters can be measured in the uncured and/or cured state. This provides the technical advantage, for example, that the exposure parameters can be adapted to different materials based on their optical properties.

In a further technically advantageous embodiment of the printing method, the light is produced using a laser or a micromirror array. This provides the technical advantage, for example, that easily controllable light sources are used.

In a further technically advantageous embodiment of the printing method, the region is a voxel. This provides the technical advantage, for example, that each voxel is exposed with a pre-calculated amount of energy.

According to a second aspect, the technical task is solved by a printing device for producing a component, comprising a calculation device for calculating an energy input for a spatial region of the component on the basis of the optical parameters of a light-curable material; and an exposure device for curing the region of the component by means of light which generates the calculated energy input into the material. The printing device achieves the same technical advantages as the printing method according to the first aspect.

In a further technically advantageous embodiment of the printing device, the calculation device is configured to calculate a time course of the energy input. This also provides the technical advantage, for example, that the production of the component is further improved.

In a further technically advantageous embodiment of the printing device, the calculation device is configured to perform the calculation on the basis of a geometry of the component. This also provides the technical advantage, for example, that even complex geometries can be created without errors.

In a further technically advantageous embodiment of the printing device, the printing device comprises a measuring device for measuring the optical parameters. The measuring device comprises, for example, a spectrometer or a light sensor for measuring a transmission or absorption at a predetermined wavelength. In general, optical parameters of the light-curable material can also be determined outside the printing device. This provides the technical advantage, for example, that narrow areas or acute angles can be printed without flaking.

In a further technically advantageous embodiment of the printing device, the exposure device comprises a laser or a micromirror array or similar device known to one or ordinary skill in the art. This provides the technical advantage, for example, that the light can be introduced into the material in an easily controllable manner.

### BRIEF DESCRIPTION OF THE DRAWINGS

Exemplary embodiments of the invention are shown in the drawings and are described in more detail below, in which:

FIG. 1 shows a diagram for a curing depth as a function of the exposure energy;

FIG. 2 shows a schematic view of a printing device;

FIG. 3 shows a schematic view of an exposure strategy;

FIG. 4 shows a schematic view of another exposure strategy; and

FIG. 5 shows a block diagram of a printing method.

### DETAILED DESCRIPTION

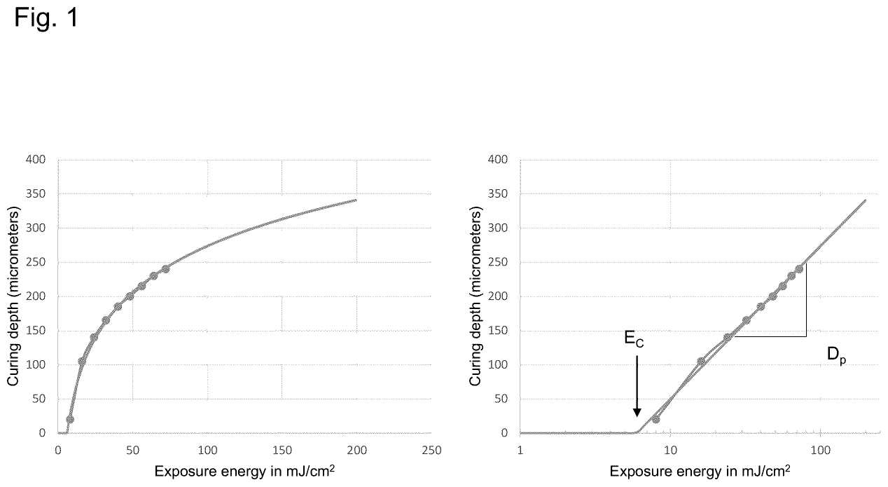

FIG. 1 shows a diagram for a curing depth as a function of the exposure energy. The curing depth in μm is plotted against the exposure energy E in mJ/cm². The curing depth C_{D} is an empirical value based on the amount of energy E irradiated. A material-specific correlation can be measured between the curing depth and the irradiated exposure energy E. The correlation is as follows:

$${C}_{D} = {D}_{p} ln ( \frac{E}{{E}_{C}} )$$

The logarithmic plot shows that there is a material-specific minimum polymerization energy E_{C} below which no polymerization takes place. The (light) penetration depth Dₚ is determined by the gradient of the straight line. Polymerization only takes place when the photoinitiators have converted all available oxygen locally by the light.

As long as this does not happen, the oxygen concentration can increase and equalize again locally through diffusion. The already locally accumulated irradiation energy is distributed over a larger volume of liquid at the expense of a reduction in the total oxygen content. This then leads to a decrease in the polymerization energy E_{C} of the total liquid and shifts the working point of the light-curing process. In this way, the time otherwise available for compensation by diffusion is shortened and the remaining cumulative energy exceeds the minimum polymerization energy E_{C} more quickly.

During exposure, an undefined amount of energy is always introduced into the liquid outside the region to be polymerized. As the material is able to accumulate this energy, the energy introduced at a certain point in time is sufficient to polymerize the material undesirably also outside the exposed region.

Finally, the intensity of the light used also has an influence. If the total irradiated energy remains the same, more flakes are formed at higher intensities. At higher intensities, the exposure times per layer are reduced. These are responsible for the overall duration of the printing process, which should be as short as possible.

This effect also depends on the material properties of the liquid starting material, for example optical properties such as opacity and pigmentation, i.e., an absorption and scattering coefficient. A process window can be found for each material in which flake formation is suppressed and delamination of individual layers is avoided. It is therefore technically advantageous if the exposure energy introduced due to light scattering outside the regions to be cured is reduced or eliminated compared to full-surface exposure.

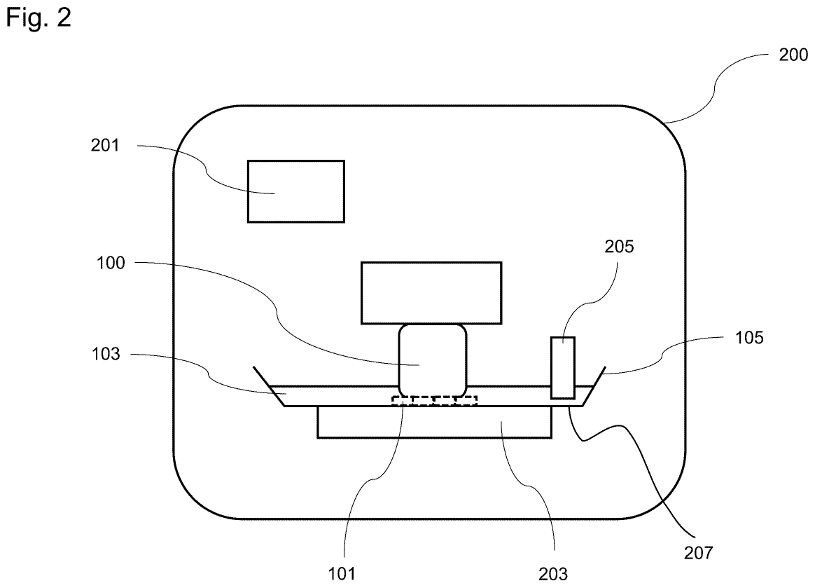

FIG. 2 shows a schematic view of a printing device 200 for producing a component based on a light-curable material 103, which is formed, for example, by a stereolithography device. The printing device 200 is used to build up a three-dimensional component 100 layer by layer from a light-curable material 103, such as a curable dental material.

In order to prevent undesired flake formation of the light-curable material 103, the printing device 200 comprises a calculation device 201 for calculating an energy input for a spatial region 101 of the component 100 on the basis of the optical parameters of the light-curable material 103.

The optical properties, such as a refractive index, an absorption, a scattering, or an optical anisotropy of the liquid and the polymerized material 103 can be measured for the wavelength used by a measuring device 205.

In addition, the kinetics of the polymerization process can be measured. For this purpose, the measuring device 205 comprises suitable sensors known to one having ordinary skill in the art with which the optical parameters of the material 103 can be measured. The measuring device 205 comprises, for example, a spectrometer or sensors with which the absorption or transmission at a predetermined wavelength can be calculated. The optical parameters are then transmitted to the calculation device 201.

The optical parameters of the light-curable material 103 can also be determined outside the printing device 200. They can then be entered into the printing device 200 so that it can further process the optical parameters.

The calculation device 201 then calculates for each region in the volume of the component 100 at the selected layer thickness the light energy actually irradiated at each point in time on the basis of the optical parameters via the radiation transport theory, for example from a variable transmission, absorption and/or scattering, taking into account the increasing polymerization layer thickness.

In addition, the irradiated light energy is not only calculated for each region in the volume of the component 100 based on the optical parameters, but also for regions outside the volume that should not cure and should be below a limit for the cumulative polymerization energy.

Thus, the time course of the intensity to be irradiated can be calculated dynamically for each layer and each region 101 of the component 100 in order to ensure polymerization within the intended region 101, while outside this region 101 the energy input is minimized by scattering.

The calculation device 201 comprises, for example, a digital memory and a microprocessor which can calculate the energy input for the respective region to be exposed and a surrounding region from the optical parameters of the material 103 and the radiation transport equation. The digital memory comprises a suitable computer program for this purpose and stores the data obtained.

In addition, the printing device 200 comprises an exposure device 203 for curing the region 101 of the component 100 below the trough 105 by means of light, which generates the calculated energy input into the material 103. The exposure device 203 is able to expose each region 101 individually. For this purpose, the exposure device 203 can be controlled by the calculation device 201.

The exposure device 203 allows the energy input to be controlled with voxel precision via gray scale values of the micromirror device. If a laser is scanned over the area instead, this can be achieved by varying the dwell times of the laser beam for each region 101. It is also possible to dynamically change the intensity of the light source in synchronization with a temporal pixel-precise change of the region 101 to be exposed.

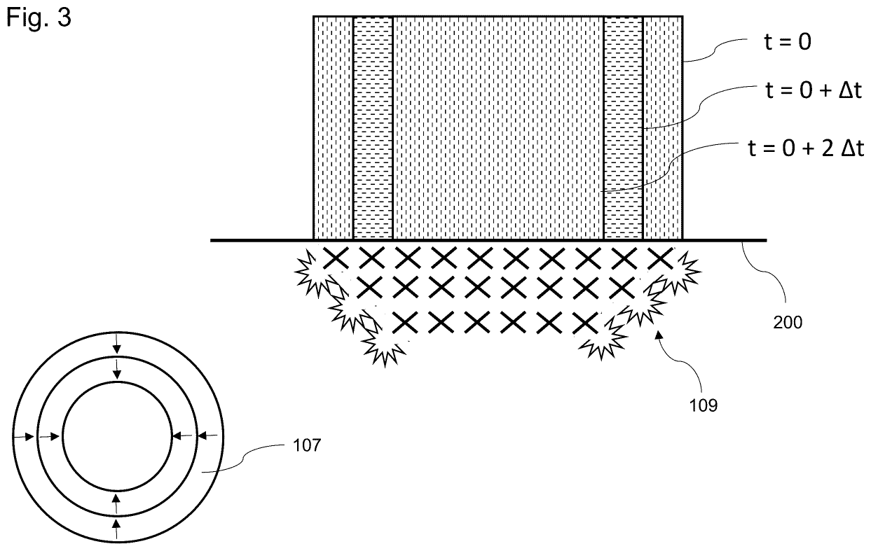

FIG. 3 shows a schematic view of an exposure strategy. For example, if the scattering 109 in the polymerized material 103 is higher than in the liquid material 103, the polymerization front runs through the exposed layer starting at the transparent trough bottom 207. The scattering 109 also increases at the edges of the component 100 in the direction of the liquid not to be exposed with increasing polymerization.

In this case, the exposed area 107 is continuously reduced during the exposure, so that the increased scattering 109 is still sufficient to cure the entire volume of the component 100, but not regions of the liquid that are outside the component 100.

If, on the other hand, the scattering 109 in the polymerized material 103 is less than in the liquid material 103, the scattering into the environment decreases steadily as the polymerization layer thickness increases. In this case, exposure is initially carried out with a reduced area 107. In the course of the exposure, the area 107 is expanded to the actual geometry size.

In this way, a changing exposure can be realized with any number of different masks that vary in dwell time, shape and transmittance. The physically correct calculation of the energy input allows the intensity in each region 101 to be adjusted in such a way that flake formation is minimized or even completely avoided. Sufficient polymerization to prevent the delamination of layers in the component is nevertheless ensured and the exposure process can be faster or time-optimized.

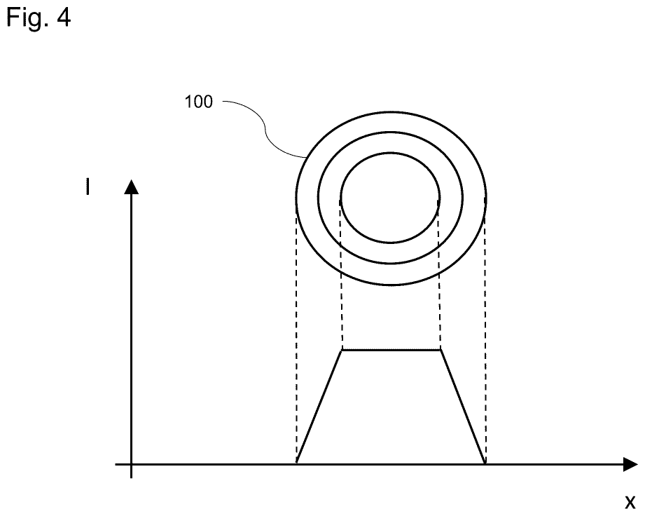

FIG. 4 shows a schematic view of another exposure strategy. In this exposure strategy, the exposure pattern is not changed over time, but the intensity I of an illumination is reduced towards the edge of the component 100. In this way, energy input through scattering can also be prevented into regions of the liquid that are outside the component 100 and should not cure.

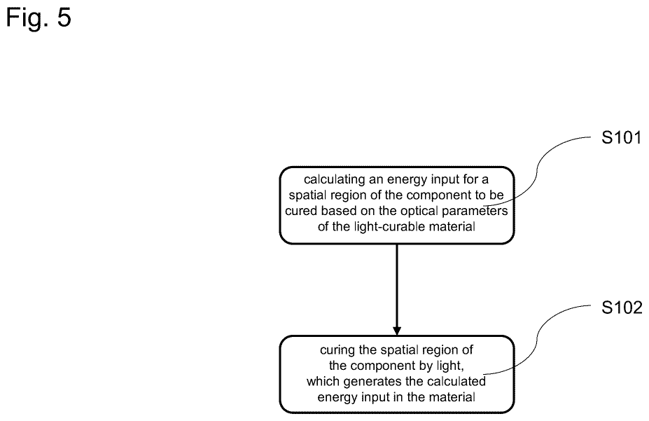

FIG. 5 shows a block diagram of the printing method for producing the component 100. The method comprises the step S101 of calculating an energy input for a spatial region 101 of the component 100 to be cured based on the optical parameters of the light-curable material 103. This is followed by the step S102 of curing the spatial region 101 of the component 100 by means of light, which generates the calculated energy input in the material 103. The steps can be carried out for each spatial region 101 of the component 100.

In this way, a suitable exposure can be calculated for a plurality of spatial regions of the component 100. The dynamic calculation by the calculation device 201 ensures that the undesired energy input into the surrounding liquid is minimized even in the case of unusual geometries of the component 100, such as narrow areas, acute or reflex angles, sharp protrusions or indentations.

For this purpose, the illuminated region can be dynamically changed or a dynamic adjustment of the selective exposure intensity or exposure or a combination of all possibilities can be made. For example, exposure can be ended prematurely at individual points.

All the features explained and shown in connection with individual embodiments of the invention can be provided in different combinations in the subject matter according to the invention in order to simultaneously realize their advantageous effects.

All method steps can be implemented by devices that are suitable for executing the respective method step. All functions performed by the features of the subject matter can be a method step of a method.

The scope of protection of the present invention is given by the claims and is not limited by the features explained in the description or shown in the figures.

### REFERENCE LIST

100 Component
101 Region
103 Light-curable material
105 Trough
107 Exposed area
109 Scattering
200 Printer or Printing device
201 Calculator or Calculation device
203 Exposure device
205 Measuring device
207 Trough bottom

1. A printing method for producing a component, comprising
calculating an energy input for a spatial region of the component based on optical parameters of a light-curable material; and
curing the spatial region of the component by light which generates the calculated energy input in the material.

2. The printing method according to claim 1,
wherein the calculation is based on a geometry of the component.

3. The printing method according to claim 1,
wherein a time course of the energy input is calculated.

4. The printing method according to claim 3,
wherein the time course is calculated based on a temporal or spatial polymerization of the region.

5. The printing method according to claim 4,
wherein an intensity of an exposure is changed based on the time course of the energy input.

6. The printing method according to claim 5,
wherein an area of the exposure is changed based on the time course of the energy input.

7. The printing method according to claim 3,
wherein a repetition frequency of a periodic exposure is changed based on the time course.

8. The printing method according to claim 3,
wherein the optical parameters of the light-curable material are measured.

9. The printing method according to claim 1,
wherein the light is produced by a laser or a micromirror array.

10. The printing method according to claim 1,
wherein the spatial region is a voxel.

11. A printing device for producing a component, comprising:
a calculator for calculating an energy input for a spatial region of the component based on optical parameters of a light-curable material; and
an exposure device for curing the region of the component by light which generates the calculated energy input into the material.

12. The printing device according to claim 11,
wherein the calculator is configured to calculate a time course of the energy input.

13. The printing device according to claim 11,
wherein the calculator is configured to perform the calculation based on a geometry of the component.

14. The printing device according to claim 11,
wherein the printing device comprises a measuring device for measuring the optical parameters.

15. The printing device according to claim 11,
wherein the exposure device comprises a laser or a micromirror array.
